(19) United States
(12) Patent Application Publication
(10) Pub. No.: US 2011/0238527 A1
(43) Pub. Date: Sep. 29, 2011

(54) Method for providing automated order procurement services and electronic web-based platform for supporting the same

(76) Inventor: Sonja Smith-Bauer, Northport, NY (US)

(21) Appl. No.: 13/065,147

(22) Filed: Mar. 15, 2011

Related U.S. Application Data
(60) Provisional application No. 61/341,114, filed on Mar. 26, 2010.

(51) Int. Cl. G06Q 30/00

(52) U.S. Cl. 705/26.8

(57) ABSTRACT

A method for providing automated order procurement services and a platform to support the automated procurement services on the Internet from a list is provided.

### CROSS REFERENCE TO RELATED APPLICATIONS

This application claims the benefit of U.S. Provisional Application No. 61/341,114, filed Mar. 26, 2010, the contents of which are incorporated herein by reference.

### FIELD OF THE INVENTION

This invention relates generally to methods for providing automated order procurement services and web-based platform for supporting the same. In particular, the present invention relates to a method for automatically obtaining supply lists from a third party posting and, using the Internet or a mobile network, procuring the items on the list and arranging delivery to client.

### BACKGROUND OF THE INVENTION

The volume of commercial transactions being conducted by communication over the Internet has grown dramatically over the past few years. These transactions typically include placement of orders by purchasers using a merchant or plurality of merchants who are paid by one or more credit card companies or banks using credit or debit accounts. Although shopping on the Internet relieves a shopper from traveling to the store to purchase items, it can be time consuming and cumbersome to find specific items on the ever increasingly complex shopping websites and cyber-malls in today's market. This trend is forecasted to continue and the volume of purchase transactions conducted over the Internet will increase, probably at an accelerated rate.

A typical Internet purchase of goods from an Internet begins with the often time consuming task of finding and selecting items for purchase. This task means spending the time paging through the virtual store and selecting items from often very large inventories so that the order can be placed with the merchant. Many times not all goods are available on one web site so cyber-hopping may be required to get all items on the list, which inevitably means even more time on the computer. The forever-busier lifestyle of parents trying to raise a family makes it difficult to spend the time looking for necessities for children such as school supplies that are often required by the school on the first day of school. In fact, this is further complicated by the fact that individual teachers can have very specific items on the lists for their students, which take extra time in the stores to locate and even if one uses the Internet, extra time is required to locate and order these items. Not only is this process repeated at least two times a school year but other clubs, organization and/or sporting teams that children belong to may also require similar shopping.

Clearly, there is long-standing need for decreasing the amount of time used for purchasing supplies necessary to participate in school, sporting teams, extra curricular activities as well as special events. As a result, it is a primary object of the present invention to introduce an entirely new concept in shopping that uses a web-based platform to obtain a list of items required to participate in a group, either form a posting party or obtained from a paid service, such as the specific school supplies of a particular teacher in a particular school, and place that order automatically with authorization and payment from the purchasing party. The time wasted by searching either on the Internet or in the store is eliminated with use of this automated program. In the implementation of this concept, it is a further object of the present invention to provide an Internet based automated order system that minimizes data entry at the user site, streamlines the order process, eliminates the time wasted searching for items either in the store or on the Internet and incorporates the buyer's billing functions directly into the order process. Likewise, it is a still further object of the present invention to facilitate drop-shipment of the completed order to the designated address or to multiple addresses as indicated in the sign-up portion of the program.

Thus, the present invention addresses some if not all of the aforementioned problems and is described more fully below. Terminology and information used in this background discussion is also applicable to corresponding aspects of the invention as described below. The reader should also understand that some of the benefits and advantages of the invention are given in this description, whereas others may become apparent later, in light of further use and study of the invention.

### SUMMARY OF THE INVENTION

The present invention provides a method for providing automated order procurement services that is designed to reduce the amount of time for a shopper to obtain required supplies that are posted on a third party web site or the hosting site. Another objective of the present invention is to provide a platform to offers incentives to organization, schools and teachers to post required school supply list for entering students in their class. Incentives can be provided either using a point system where points are earned for each participant that automatically purchases supplies on the posted listed using the system or cash paid directly to the teacher, school or organization. These points can be redeemed for items, i.e. teachers can be given points for posting a supply list for students in a particular school, grade and class for supply items they may need throughout the year.

In one embodiment of the present invention, the method comprises the steps of:

(a) receiving a purchase request from a customer via a network interface configured to transmit data to and receive data from an external network over the Internet and a network microcomputer configured to process data received from an input device and to transmit the processed data and external network data associated therewith through the network interface, said request including a group identifier;

(b) accessing a database initialized with information from a third party using said group identifier via said network interface configured to transmit data to and receive data from an external network over the Internet and said network microcomputer configured to process data received from an input device and to transmit the processed data and external network data associated therewith through the network interface using said computer network, said database having said information including a list of supplies required or recommended to participate in a group or to complete a task

(c) automatically selecting at least one qualified vendor from a predefined list of qualified vendors and generating a purchase order including said list of supplies based on information selected from the group consisting of pricing, product availability, selection, preferred vendor status and combinations thereof;

(d) forwarding said purchase order to said at least one selected qualified vendor for fulfillment; and

(e) generating a notification of fulfillment of said purchase order and delivery details for delivery of items in said purchase order.

In another one embodiment of the present invention, the third party is a schoolteacher and the group identifier includes at least one identifier selected from the group consisting of school, class, teacher, club, team and combinations thereof.

In yet another embodiment of the present invention, there is provided an electronic web based platform for supporting the method for providing automated order procurement services of the present invention.

In yet another embodiment of the present invention, an electronic web based platform configured for supporting a method for providing automated order procurement services is provided. The platform comprises the steps of providing an input screen via a network interface configured to transmit data to and receive data from an external network over the Internet and a network microcomputer configured to process data received from an input device and to transmit the processed data and external network data associated therewith through the network interface so that a request list can be populated that will be used to generate a purchase order. Once the user is done populating the request list and the purchase order is generated, a request to fulfill the purchase order is generated that provides access to said request list so that at least one qualified vendor is selected from a predefined list of qualified vendors to finalize the purchase order. The criterion used to select which vendors will be used is based on a logic that selects the vendors automatically based on pricing, product availability, selection, preferred vendor status and combinations thereof. Once the vendors have been selected and the purchase order generated the purchase order is sent to said at least one selected qualified vendor for fulfillment. This automatically generates a notification of fulfillment of said purchase order and sets forth the delivery details for delivery of items in said purchase order.

Additional embodiments and details of the embodiments of the present invention are provided in connection with the figures of the application in the Detailed Description section of the present invention and the claims. All objects, features, and advantages of the present invention will become apparent in the following detailed written description.

### BRIEF DESCRIPTION OF THE FIGURES

FIG. 1 shows a flow chart of the procurement method of the present invention.

### DETAILED DESCRIPTION OF THE INVENTION

In this ever complicated fast paced world children are still going to school, playing on organized sport teams, participating in clubs and going to camp, as well as, participating in many other organized activities. At the beginning of each school year, and sometimes often throughout the year, every student is required to purchase a specific list of items that are not provided for by the school. In the case of private schools, often all supplies must be purchased and replenished for the students throughout the school year. Since each teacher has different methods of teaching, often the supplies that they require include the standard supplies, as well as, very specific items. Since all parents are in the same situation at the same time, getting in and out of the stores to purchase the items is a true horror. The same is true for surfing the Internet for these items.

Families with multiple children must shop from several lists at a time while in the store or on the Internet. Elementary school children may have one list, while middle school and high school students may have multiple lists from multiple teachers. Assuming the parent survives the purchasing stage, then there is still the task of unpacking and re-sorting the items at home in order to get the student ready for school. Often, not all supplies are available at one store, or on one website which necessitates travel to another store or adds additional delivery charges for using different web sites. This is often repeated in January, and periodically throughout the school year.

As hard as many parents try, they often never truly get all that is required and if they do many, many hours, if not days, are wasted. Teachers become frustrated when children arrive at school without their proper supplies. The reason for this is usually because parents have become frustrated trying to find sold-out items, or trying to purchase/organize supplies from multiple lists. This leads to students is becoming upset or feeling left out if they are the ones without a particular supply needed throughout the day. To help parents with this problem Parent Teacher Associations (PTA) hold “school stores” in order to raise money for the PTA by selling school supplies two or three days before school begins. However, this is often during the workday thereby shutting out working parents.

Thus, what is needed is an automated process that once a user signs up for the service and provides the proper identifying information, a list of required supplies is obtained form either a third party website, such as a school website, or in the alternative from a postings on a hosted website made by the teacher or school requiring the supplies.

The present invention may be executed in a variety of systems, including a variety of computing systems and electronic devices under a number of different operating systems. In a preferred embodiment of the present invention, the computer system that incorporates communication features that provide for telephony, enhanced telephony, messaging and information services. Preferably, in order to enable at least one of these communication features, the computer system can be connected to a network, such as the Internet by either a wired link or wireless link. In addition, the computer system may be a stand-alone system or part of a network such as a local-area network (LAN) or a wide-area network (WAN). Therefore, in general, the present invention is preferably executed in a computer system that performs computing tasks such as manipulating data in storage that is accessible to the computer system. In addition, the computer system includes at least one output device and at least one input device.

The computer system used in connection with the system of the present invention includes a universally accessible database and market server systems each communicated via a bi-directional communications medium with a network. The network is advantageously a universally accessible network, such as the Internet. The communications medium may include wired or wireless communications or other communications media that enables bi-directional transmission of data. Moreover, the communications medium may include a link to a network, such as the Internet, or a direct data link.

Data exchange across the communications medium is advantageously performed in at least one of multiple available data transmission protocols and is preferably supported by a common data structure format, such as the extensible mark-up language (XML) data structure format. Data transmission protocols may include, but are not limited to, Transmission Control Protocol (TCP), Internet Protocol (IP), Hypertext Transfer Protocol (HTTP), and Bluetooth. In addition, data may be transmitted in a secure manner via encryption or by technologies, such as secure socket layer (SSL) or virtual private networks (VPN).

Using at least one of the computer systems described above, the method and system of the present invention automatically fills the supply order using one or multiple vendors, bills the customer and ships it to the shipping address provided. Items from each list of supplies can be pre-sorted and placed in a single box with the child's name or can be shipped in different boxes if different vendors are used. This automated system would be in contact with the school website or look for postings from the school/teacher throughout the year for additional items that may be necessary. An e-mail message, text message or phone call will be sent/made to the customer that additional supplies have been requested and once authorized the order is automatically filled, billed and sent to the delivery address provided.

The automated method can be customized to make shopping for school supplies simple, efficient and cost effective for parents, and the method ensures that students have their required materials for the first day of school. In addition the method can also help the PTA/school make additional money. That is, the method of the present invention can be configured to provide incentives to PTA/school/teachers/organization for promoting use of the service to parents by providing a percentage of sales to the PTA/school/teachers/organization. In addition, since teachers frequently purchase supplies, small rewards for the children and room decorations with their own money, the incentives for promoting the system to parents can be in the form of a credit or a point system that the teacher can use for school supplies. This way the teacher can get the supplies and decorations she/he wants without reaching into their own pocket. One task, in addition to promoting the service that would receive incentive points, is uploading their class supply list onto the school website, if not already routinely done, or in the alternative on a designated website of a hosting company. Additional incentives can be provided to teachers based on the number of “special items” items placed on the list for that year. These “special items” can be items that are new to the market or items that make the most profit for the supplier because of special purchasing arrangements.

Teachers could also post materials required for special projects on the school website or designated third party website with the proper school identifier. These can be obtained automatically by the automated method and e-alerts sent to parents letting them know when a project is due, its scope and the supplies needed or suggested. If the parent or student at sign up opts into this service, the recommended supplies list would automatically be sent to the parent via email. The parent or student would have the option to edit and place the order. The service can charge an annual fee, on an order basis, or can be free and money can be generated from the sale of goods, advertising on the site and/or sponsorships. Thus, with a click of a computer button the task of finding, ordering, sorting and delivery can be completed without any last minute late night department store runs.

The automated order procurement method can also be used to fulfill supply needs for children (and adults) enrolled in clubs, teams, camps, and the like, that also have supply lists/requests. This could include lists recommended by vendors and publications in order to complete projects and hobbies, such as recipes, home improvements, car repairs, boat and motor seasonal maintenance as well as other special projects. Individuals that subscribe to particular magazines, such as Gourmet magazine, Cooking with Julia, This Old House, Costal Living, Better Homes and Gardens, Good Housekeeping, Martha Stewart Living, etc. can opt into a service that provides the automated order procurement method of the present invention for supplies necessary to complete special projects and/or recipes listed in particular magazine. Supply list for special projects or recipes listed in these publications can either be automatically fulfilled and sent to the customer or an e-alert can be generated and sent to the customer announcing these new projects/recipes and requesting authorization to automatically fulfill and order of supplies for the announced project/recipe. Also particular stores such as Home Depot® and Lowes® that teach projects can offer the order procurement services of the present invention that can automatically shop for and deliver products from a detailed list from their stores that are necessary to fulfill a particular seasonal project such as a spring planting project, fall winterization project, and the like.

Another use for the automatic procurement method is on-line registrations for camp, soccer, baseball, basketball, dance class, gymnastics, art classes and the like may also be done using the information provided by the customer.

Other service provided by the hosting website throughout the school year could include offering textbooks as e-books, so that students do not need to carry heavy books home with them, or have to do without the text book, in the event a textbook was left at school. A license to use all or part of the textbooks can be purchased for a specified period of time, depending upon the need for the book.

The present invention is directed to a method for providing automated order procurement services designed to provide the aspects of the present invention described above. In addition the present invention also provides an electronic Internet/web-based platform configured for supporting a method for providing automated order procurement services. Each of these embodiments of the present invention is further described below.

In one embodiment of the present invention, a method for providing automated order procurement services is provided that comprises the following steps. First, after the customer enrolls in the service and provides all of the necessary information for billing, delivery, school/teacher identification along with the schools website, a purchase request from the customer is constructed including the group identifier used to identify the organization/school/teacher/event in which the customer is interested in using the automated method to fulfill a supply list. Once this is received the method accesses a database initialized with information from a third party and uses the group identifier to obtain information including a list of supplies required to participate in a group. The method uses search engines and computer based logic, much of which is known in the art or can be written by a skilled computer programmer, to automatically select at least one qualified vendor from a predefined list of qualified vendors to fulfill the order based on information selected from the group consisting of pricing, product availability, selection, preferred vendor status and combinations thereof.

Once the vendors are selected, a purchase order is electronically sent to the chosen vendors for fulfillment. Once the order is fulfilled it is either directly sent to the customer or to a sorting location where the items are prepackaged by group identifier. For example, each child in the family will receive a package with all of the supplies required for his or hers class. Once the order is fulfilled and prior to/or simultaneous with shipping a notification of fulfillment of said purchase order and delivery details for delivery of items is generated and sent to the customer. This is done to assure the customer that there information has been received and the items are being shipped.

In one embodiment of the present invention a series of questions are generated at sign in that are designed to generate specific identification codes that can be used to search the world wide web and/or a privately held data base to obtain information to be included in orders to be placed and for delivery. At sign in, the user can be asked if they would like to create a personal, organizational or company list that can be used with the system of the present invention. A personnel list may include weekly or monthly grocery shopping, monthly medications, month by month birthday presents. These lists can be populated manually in part and then augmented by particular guidelines set in the system. For example, a grocery list can be generated that includes the staple items necessary for the week and the a set of instructions setting money limitations can be provided for fresh fruit of the week, fresh vegetables of the week or even the cut of meat on sale to be included in the order.

As for an organizational list, the list can consist of a list of supplies off of a school list, girl's scout troop supply list, a boy scout troop supply list, art class supply list, a summer camp supply list, a sport supply list, or a fun list that allows for selection and delivery of a random sampling of items using the system of the present invention based on a set of guidelines including price, frequency of delivery, size and profile of different interests set by the user at sign up. These an include selection of items from articles published in magazines, recipe of the month supplies, the latest electronics or tickets to local concerts and events. Prior to sale an e-mail, text, twitter, or other communication can be sent to confirm that you would like the item delivered. Finally, a company list can include a list of supplies necessary for a company, business, medical or dental practice or an office that are needed each period and can be automatically selected and delivered.

To generate these preferences a user can be asked a series of questions when signing into the program for the first time. For example, when signing in a person can be asked to input the postal code of the schools in which their children attend. Once this is inserted a drop down screen will list all of the schools in that postal code and instruct the user to highlight which school or schools the children attend. If more than one school is entered the screen will spit and the next drop down screen will appear asking for first the grade o that each child is in and then the actual teacher that they have,

Each of these answers starting with the postal code generates a specific identifier for the supply list associated with that child's class. Once this is generated the system will use that generated code to identify the list of supplies that will be used by the system and the order will be automatically shopped, purchased and delivered to the address on record. Much like “apps” on the i-touch® a credit card, paypal account, or checking account would be required to be placed on file when registering for the service. This account will be automatically charged or debited once the order is placed and ready for delivery. A frequency code can also be applied to the list identifier that will trigger the platform to check the list for updates and additions so that supplies are automatically shopped for, priced and delivered without you even thinking about it. This is essential for all busy parents that are responsible for making sure that their children have the needed supplies for school, girls scouts, boys scout, holidays, as well as other activities and clubs.

In the initial registration, the user will also be asked whether they subscribe now to any magazines, a drop down list of magazines maybe be provided with each magazine having a specific identifier code. Once these are checked then the user would be asked whether they would like to have any recipe supplies, suggested books, or other items associated with a list generated by that magazine fulfilled and delivered by the same service. This would be especially useful for a person that is a wine spectator and subscribes to the wine spectator magazine that provides a short list of must try wines under a given price. Instead of reading about the wines and making a mental note to go to the wine store to purchase these wines before the month is over and never getting to it, now with the automated service the wines will be delivered and enjoyed even before you finish reading the magazine.

If a school, a school teacher, a magazine or other business or social organization that is entered into the platform of the present invention that either does not have a list or an identifier code associated with a list either on the database or on the world wide web then a message would be automatically sent to the school, school teacher, magazine, business or social organization that does not have a list inviting them to participate in the program by creating a list or allowing the platform of the present invention to create and make a list for automatic shopping.

In yet another embodiment of the present invention an e-alert, text message, twitter, facebook message, telephone call or post card is sent to the customer that the order is fulfilled and on its way to the selected delivery location. Should items on the list not be available the customer and/or the teacher can be messaged by e-alert, text message, telephone call or post card to select acceptable alternatives. If during the enrollment process the customer selects the option that no substitutions will be accepted, the automated order procurement method will automatically generate a second purchase order containing items that was not available in the first purchase order. Once the order is completely fulfilled the customer would be notified by e-alert, text message, telephone call or post card. The automated method would continue to try different vendors to obtain the back-ordered items and as goods become available the items will be delivered to the delivery address provided clearly marked with the class identifier.

As discussed above this method can be used for organized sport teams/leagues, organized clubs such as brownies, girls and boys scouts, summer camps, dance classes, and other organized groups that require each participant to have specific items in order to participate.

In one embodiment of the present invention, the teacher, school, organization or third party supplying the supply list information can be compensated for posting the supplies list on the database using the automated method or making the list available on the organization's/school's/teacher's website. Authorization to access the list may be required which the customer may provide. Authorization to enter the list can be provided in the form of an access code or password for accessing the information. In the alternative, the classroom supply list can also be easily posted on the automated services website using the same drop down questions by a user to identify the school by postal code, class code and teacher so that when a user answers the same questions the same identifier code is generated and easily linked with the proper list. The teacher would not only be able to post the supply list free of charge but with each list posted the school can generate points that can be accumulated for additional supplies for the school. Other means and/or computer language can be used to compensate the club, charity, teacher, school or organization for each list placed on the database and/or for each order placed using the list by the claimed method as described herein.

One way a list can be generated by a teacher/organization is using a bar code reader to identify the items as often done with a bridal registry. The bar code reader can be provided by a sponsoring store or can be a phone or personal device that has the capability of reading and storing bar codes. This information can be e-mailed to the host site or posted on the school's, teacher's or organization's website with the proper identifier. This would assure that the exact item requested is what is purchased.

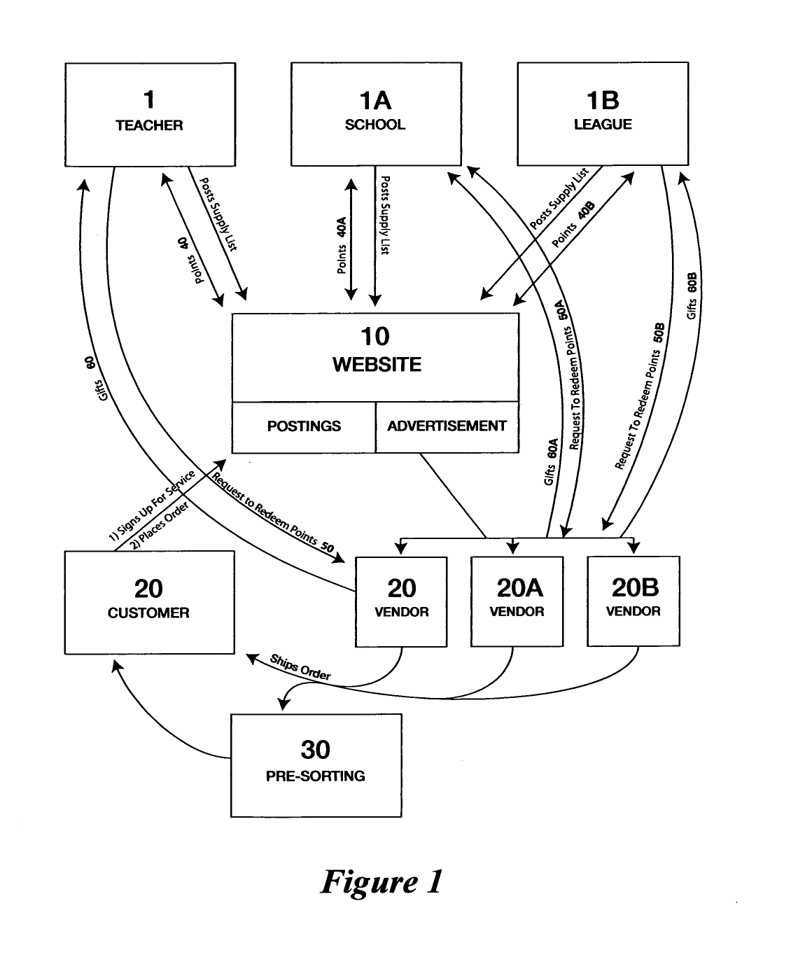

FIG. 1 is a flow chart that shows all of the participants of the claimed method and how each participant interacts using the automated method. The block diagram has the hosting website (10) in the middle which receives information from the teacher/school/team/league/vendor (Gourmet magazine, Home Depot, as detailed above etc. (1, 1A, and 1B) about the supplies required for a particular group. The website (10) can be configured using standard industry logic to have advertisements that can be viewed when on the website or e-mailed to the user according to standard industry practice. The hosting website (10) provides the automated order fulfillment services of the present invention once the customer (20) enrolls and provides authorization. Once the order is placed; the hosting website contacts one or more vendors (20, 20A, 20B) to fulfill the order and can either ship the items to a pre-sorting center (30) that sorts all the items in one package and ships it to the customer (20) or the items can be directly shipped to the customer (20) if the pre-sorting option is not selected.

Also shown in FIG. 1 of the present invention are points that can be earned and provided to the teacher, school, team/league (1,1A,1B) that can be redeemed for supplies by sending a request to redeem points (50,50A,50B) to the vendors (20,20A,20B). Gifts (60, 60A and 60B) are then sent to the teachers, school, team/league or other organization for the redemption of the points earned in the program. The key to this basic platform of the invention is the automated fulfillment method discussed above that obtains information from a third party website and uses it to place, fulfill, charge and deliver the order including the items from the provided list or third party website.

In yet another embodiment of the present invention, an electronic Internet/web based platform configured for supporting the method for providing automated order procurement services described above is provided. The web-based platform uses standard industry construction and devices to support the proprietary method of the present invention. In particular, the electronic web based platform configured for supporting a method for providing automated order procurement services is specifically configured to comprise the following steps. Receiving a purchase request from a customer including a group identifier and accessing a database initialized with information from a third party using the group identifier. The information including a list of supplies required to participate in a group. The platform supports automatically selecting at least one qualified vendor from a predefined list of qualified vendors and generating a purchase order including the list of supplies obtained form the third party list.

In the alternative, the group/teacher could post the list on the hosting website and the platform is configured to sort the information according to group identifier. Once a customer places an order, the electronic web-based platform matches the sorted information with the incoming customer order having the same group identifier. The electronic web based platform supports the selection of vendors based on selection criteria selected from the group consisting of pricing, product availability, selection, preferred vendor status and combinations thereof. The platform is configured to automatically forward the purchase order to at least one selected qualified vendor for fulfillment and to generate a notification once fulfilled. The platform provides the logic to either send the items directly to the customer or to a pre-sorting station prior to final delivery.

In another embodiment of the present invention, the e-based platform is configured to support e-advertising and advertising banners for generating additional income. The electronic web-based platform can also be configured to support the method for providing automated order procurement services of the present invention including automatically generating a second purchase order containing items in the first purchase order that were out of stock at time of fulfillment of first order and automatically fulfilling the second purchase order as goods become available. Additional aspects can be incorporated into the basic platform that further support the automated procurement method of the claimed invention and still fall within the scope of the claimed invention.

In another embodiment of the present invention, the list generated for you can be sent to others on your facebook page. Using this feature of the claimed system others either in the same class or group can purchase these items either using the automated system of the present invention or on their own. Incentives can be provided to the generator of the list, as well as, the sharing person should any facebook connection lead to sales. Advertisement and special prices of the items on the list can make it cheaper to use the service based on the system of the present invention than to purchase items without the service. Credit cards and lending institutions could offer incentives for using their products to pay for any items on a list that are fulfilled using the system of the present invention. This makes the automated system not only easier but more cost affective as well.

It is important to note that, although the present invention has been described in the context of a fully functional computer system, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal-bearing media include, but are not limited to, recordable-type media such as floppy disks or CD-ROMs and transmission-type media such as analogue or digital communications links.

While the foregoing description is exemplary of the preferred embodiments of the present invention, those of ordinary skill in the relevant arts will recognize the many variations, alterations, modifications, substitutions and the like as are readily possible, especially in light of this description, the accompanying drawings and claims drawn thereto. For example, it is anticipated that the entire initial database creation of lists populated by third parties could be automated through the provision of a software application specifically designed for this purpose. Likewise, with the implementation of an additional function involving an implementation of the trademark “ADOBE PDF” standard, the user requestor and/or purchasing agent could be given the opportunity to preview the total cost at the time of order entry or approval or, with an implementation involving a Macromedia trademark “FLASH” standard, user instructions could be verbalized and/or animated. In any case, because the scope of the present invention is much broader than any particular embodiment, the foregoing detailed description should not be construed as a limitation of the scope of the present invention, which is limited only by the claims appended hereto.

In addition, while the figure and the description of the present invention provided above describe preferred embodiments of the present invention, various modifications of, for example, components, materials and parameters, will become apparent to those skilled in the art, and all such modifications and changes are intended to fall within the scope of the claims of the present invention.

What is claimed is:

1. A method for providing automated order procurement services, comprising the steps of:
(a) receiving a purchase request from a customer via a network interface configured to transmit data to and receive data from an external network over the Internet and a network microcomputer configured to process data received from an input device and to transmit the processed data and external network data associated therewith through the network interface, said request including a, group identifier;
(b) accessing a database initialized via said network interface configured to transmit data to and receive data from an external network over the Internet and said network microcomputer configured to process data received from an input device and to transmit the processed data and external network data associated therewith through the network interface using said computer network, said database having information from a third party using said group identifier, said information including a list of supplies required to participate in a group or to complete an individual project;
(c) automatically selecting at least one qualified vendor from a predefined list of qualified vendors and generating a purchase order based on stored preferences including pricing, product availability, selection, preferred vendor status and combinations thereof;
(d) forwarding said purchase order to said at least one selected qualified vendor for fulfillment; and
(e) generating a notification of fulfillment of said purchase order and delivery details for delivery of items in said purchase order.

2. The method for providing automated order procurement services of claim 1 further comprising (f) automatically generating a second purchase order containing items in said first purchase order that were out of stock at time of fulfillment of first order and automatically fulfilling said second purchase order as goods become available and delivering items according to step (e).

3. The method for providing automated order procurement services of claim 1 wherein said third party is a school teacher and said group identifier includes at least one selected from the group consisting of school name, a class in a particular school, a teacher, a club, a team and combinations thereof.

4. The method for providing automated order procurement services of claim 1 wherein said third party is compensated for posting supplies list on said database.

5. The method for providing automated order procurement services of claim 1 wherein a user, club, charity or class is compensated for each order placed using said method.

6. The method of claim 4 wherein said third party is a particular school, a class in a particular school, a teacher of a class in a particular school, a club, a league, a team and combinations thereof.

7. An electronic web based platform configured for supporting a method for providing automated order procurement services comprising the steps of:
(a) receiving a purchase request from a customer via a network interface configured to transmit data to and receive data from an external network over the Internet and a network microcomputer configured to process data received from an input device and to transmit the processed data and external network data associated therewith through the network interface, said database, said request including a group identifier;
(b) accessing a database via said network interface configured to transmit data to and receive data from an external network over the Internet and said network microcomputer configured to process data received from an input device and to transmit the processed data and external network data associated therewith through the network interface using said computer network, said database having initialized with information from a third party using said group identifier, said information including a list of supplies required to participate in a group or complete a project;
(c) automatically selecting at least one qualified vendor from a predefined list of qualified vendors and generating a purchase order including said list of supplies based on stored preferences including pricing, product availability, selection, preferred vendor status and combinations thereof;
(d) forwarding said purchase order to said at least one selected qualified vendor for fulfillment ;
(e) generating a notification of fulfillment of said purchase order and delivery details for delivery of items in said purchase order; and said web based platform configured to support paid e-advertising.

8. The electronic web based platform configured for supporting a method for providing automated order procurement services of claim 7 further comprising (f) automatically generating a second purchase order containing items in said first purchase order that were out of stock at time of fulfillment of first order and automatically fulfilling said second purchase order as goods become available and delivering items according to step (e).

9. The electronic web based platform configured for supporting a method for providing automated order procurement services of claim 7 wherein said third party is a schoolteacher and said group identifier includes at least one selected from the group consisting of school, class, teacher, club, team and combinations thereof.

10. The electronic web based platform configured for supporting a method for providing automated order procurement services of claim 7 wherein said third party is compensated for posting supplies list on said database.

11. The electronic web based platform claim 10 wherein said third party is a particular school, a class in a particular school, a teacher of a class in a particular school, a club, a league, a team and combinations thereof.

12. The electronic web based platform for supporting a method for providing automated order procurement services of claim 7 wherein a user, club, charity or class is compensated for each order placed using said method.

13. The electronic web based platform for supporting a method for providing automated order procurement services of claim 7 further configured to support sponsor based advertising.

14. The method for providing automated order procurement services of claim 1 further comprising (g) authenticating the identity of said customer.

15. The electronic web based platform for supporting a method for providing automated order procurement services of claim 7 further configured to authenticate the identity of said customer.

16. The method for providing automated order procurement services of claim 1 further comprising a means to prevent access to information concerning a group without the prior authorization of the customer about whom such records pertain.

17. The electronic web based platform for supporting a method for providing automated order procurement services of claim 7 further configured to prevent access to information concerning a group without the prior authorization of the customer about whom such records pertain.

18. The method for providing automated order procurement services of claim 14 wherein the authenticating step includes identifying a specific computer from which used the original purchase order was received.

19. The electronic web based platform for supporting a method for providing automated order procurement services of claim 15 wherein said platform is configured to authenticate the identity of said customer by the computer being used.

20. The method for providing automated order procurement services of claim 1 wherein said list of supplies required to participate in a group includes the universal bar codes for each item on said list.

21. The electronic web based platform for supporting a method for providing automated order procurement services of claim 8 further configured to accept and identify items using universal bar codes of items on said list of supplies required to participate in a group.

22. An electronic web based platform configured for supporting a method for providing automated order procurement services comprising the steps of:
(a) providing an input screen for populating a request list via a network interface configured to transmit data to and receive data from an external network over the Internet and a network microcomputer configured to process data received from an input device and to transmit the processed data and external network data associated therewith through the network interface;
(b) generating a purchase order including the items in said request list;
(c) accessing said request list and automatically selecting at least one qualified vendor from a predefined list of qualified vendors based on stored preferences including pricing, product availability, selection, preferred vendor status and combinations thereof via said network interface configured to transmit data to and receive data from an external network over the Internet; or said network microcomputer configured to process data received from an input device and to transmit the processed data and external network data associated therewith through the network interface using said computer network, said database having ;
(d) forwarding said purchase order to said at least one selected qualified vendor for fulfillment; and
(e) generating a notification of fulfillment of said purchase order and delivery.
